(19) United States
(12) Patent Application Publication
(10) Pub. No.: US 2024/0329936 A1
(43) Pub. Date: Oct. 3, 2024

(54) SECURE MULTI-PARTY COMPUTATIONS

(71) Applicant: SEDICII INNOVATIONS LTD., Waterford (IE)

(72) Inventor: Miguel DE VEGA RODRIGO, Santa Cruz de Tenerife (ES)

(73) Assignee: SEDICII INNOVATIONS LTD., Waterford (IE)

(21) Appl. No.: 18/710,933

(22) PCT Filed: Nov. 23, 2022
(86) PCT No.: PCT/EP2022/082986

§ 371 Date: May 16, 2024

(30) Foreign Application Priority Data
Nov. 23, 2021 (EP) 21210077.0

(51) Int. Cl. G06F 7/58; G06F 7/523

(52) U.S. Cl. CPC G06F 7/588; G06F 7/523

(57) ABSTRACT

A secure multiparty computation method permits the computation of an arithmetic function ƒ which can be expressed as the addition of A groups of multiplications of a set S of private input secrets {s₀, s₁, . . . , sₛ₋₁}. Dealer nodes holding the secrets are provided with a base blinding factor ρₐ whose inverse is the sum of a set of pseudorandom numbers each of which is associated with a respective computing node and is not shared with other computing nodes. Each dealer node is further provided with an exponent blinding factor λ_{a,m} specific to the secret being contributed, where all of the exponent blinding factors sum to unity. The dealer nodes share with the computing nodes the product of the secrets with the base blinding factor raised to the exponent blinding factor. Each computing nodes can independently and without sharing computations, generate from the product of shares it receives from the dealer nodes a result share. Summing the result shares provides the result of the computation. In this way a sum of products can be computed by the computing nodes without requiring any messages to pass between the computing nodes during the computation.

### TECHNICAL FIELD

This invention relates to Secure Multi Party Computation (SMPC) protocols.

### BACKGROUND ART

Secure Multi Party Computation (SMPC) enables a set of parties to collaboratively compute a function over their inputs while keeping them private. There are several SMPC flavours described in the literature, including Yao's Garbled Circuits (Yao, Andrew Chi-Chih (1986). “How to generate and exchange secrets”. 27th Annual Symposium on Foundations of Computer Science (SFCS 1986). Foundations of Computer Science, 1986., 27th Annual Symposium on. pp. 162-167. doi:10.1109/SFCS.1986.25. ISBN 978-O-8186-0740-0.), GMW (O. Goldreich, S. Micali, A. Wigderson, “How to play ANY mental game”, Proceedings of the nineteenth annual ACM symposium on Theory of Computing, January 1987, Pages 218-229, doi:10.1145/28395.28420; and T. Schneider and M. Zohner, “GMW vs. Yao? Efficient secure two-party computation with low depth circuits,” in Financial Cryptography and Data Security (FC'13), ser. LNCS, vol. 7859. Springer, 2013, pp. 275-292.), BGW (Ben-Or, M., Goldwasser, S., Wigderson, A.: Completeness theorems for Non-Cryptographic Fault-Tolerant Distributed Computation. In: Proc. ACM STOC '88, pp. 1-10 (1988)), SPDZ (Damgård I., Pastro V., Smart N., Zakarias S. (2012) Multiparty Computation from Somewhat Homomorphic Encryption. In: Safavi-Naini R., Canetti R. (eds) Advances in Cryptology—CRYPTO 2012. CRYPTO 2012. Lecture Notes in Computer Science, vol 7417. Springer, Berlin, Heidelberg. https://doi.org/10.1007/978-3-642-32009-5_38), BMR (Beaver, D., S. Micali, and P. Rogaway. 1990. “The Round Complexity of Secure Protocols (Extended Abstract)”. In: 22nd Annual ACM Symposium on Theory of Computing. ACM Press. 503-513), and GESS (Kolesnikov, V. 2005. “Gate Evaluation Secret Sharing and Secure One-Round Two-Party Computation”. In: Advances in Cryptology—ASIACRYPT 2005. Ed. by B. K. Roy. Vol. 3788. Lecture Notes in Computer Science. Springer, Heidelberg. 136-155).

There are two main constructions of SMPC: Circuit Garbling (CG) and Linear Secret Sharing (LSS). Circuit garbling requires encrypting keys in a specific order to simulate the function evaluation. Linear Secret Sharing computes shares from the inputs and distributes them among the nodes. In this disclosure we focus on SMPC flavours using LSS.

The following is a list of the main roles for the nodes participating in a SMPC computation:
Dealer node: These nodes contribute inputs to the computation
Computing node: These nodes perform the actual SMPC computation on the inputs provided by dealer nodes
Result node: These nodes reconstruct the result from a finished SMPC computation

LSS SMPC protocols comprise the following three phases:
Phase 0 (optional)—Pre-processing: Some LSS SMPC protocols require nodes to run preliminary computations like the generation of multiplicative triplets in Beaver's version of BGW (Beaver, D. “Efficient Multiparty Protocols Using Circuit Randomization”. In: Advances in Cryptology—CRYPTO'91. Ed. by J. Feigenbaum. Vol. 576. Lecture Notes in Computer Science. Springer, Heidelberg. 420-432), or in SPDZ. These computations are not related to the private inputs of any particular SMPC computation and therefore can take place in a previous offline phase.
Phase 1—Share distribution: Each dealer node breaks down each private input to the computation into a number N of shares and sends each share to a different computing node. Each share reveals no information about the private input. It is only when all N shares from a private input are gathered that it can be reconstructed.
Phase 2—Computation: Each computing node has one share from each private input to a computation. The computation consists of evaluating the output of a function over the private inputs. In order to do this, the computing nodes perform operations on their shares that depend on the specific function to be evaluated by the SMPC protocol.
Phase 3—Result reconstruction: After Phase 2, each computing node has obtained a share from the result of the computation (i.e. the function to be evaluated). They send their share to one or several result nodes. After gathering all N shares from the result, a result node can reconstruct the output of the function that was jointly evaluated.

For example, assume that two dealer nodes have each one string. They would like the network of computing nodes to evaluate the result from comparing the two strings and to communicate this result to a result node. The strings are private to the dealer nodes, so they should not be sent over to the computing nodes in plaintext or in encrypted form. Each dealer node breaks down their private string into N shares and send each share to a different computing node. After receiving one share per each one of the two strings to be compared, the computing nodes follow the SMPC protocol to obtain a share of the result from the computation. This result could be a Boolean representing a string match with a TRUE value and a string mismatch with a FALSE value. Each node sends their share of the result to a result node, which reconstructs the TRUE or FALSE result from the string comparison.

The main problem with SMPC is the communication complexity. A large number of message exchanges and/or communication bandwidth is required in order for the computing nodes to collaboratively obtain in Phase 2 a share of the result of the function being evaluated when this function is complex. By complex function we mean a function with a large number of inputs and a large number of operations on those inputs. Real-world applications of SMPC typically require complex functions, which severely affects the applicability of SMPC in production scenarios.

For example, in BGW SMPC computing nodes evaluate arithmetic functions on integer inputs comprising additions and multiplications. Computing nodes running BGW can process additions without the need to exchange any message. However, the evaluation of multiplications requires the exchange of messages. Complex functions will have additions and multiplications, making the overall BGW function evaluation slow.

We refer herein to SMPC flavours evaluating arithmetic functions as SMPC in the arithmetic setting. The focus of the invention is on the evaluation with SMPC of any function in the arithmetic setting. In the arithmetic setting, a function can be represented without loss of generality as the sum of groups of secret products. In this setting, secrets are natural, integer, real or complex numbers.

The evaluation of a general function requires the computation of products in the arithmetic setting. State-of-the-art SMPCs require nodes to exchange messages in order to jointly evaluate arithmetic products. The exchange of messages is many orders of magnitude slower than computations on a local CPU. This is the reason why the jointly evaluation of nontrivial functions in standard SMPCs is orders of magnitude slower than on a centralized server.

### DISCLOSURE OF THE INVENTION

A secure multiparty computation method is provided which permits the computation of an arithmetic function ƒ which can be expressed as the addition of A groups of multiplications of a set S of private input secrets {s₀, s₁, . . . , sₛ₋₁}. Dealer nodes holding the secrets are provided with a base blinding factor ρₐ whose inverse is the sum of a set of pseudorandom numbers each of which is associated with a respective computing node and is not shared with other computing nodes. Each dealer node is further provided with an exponent blinding factor λ_{a,m} specific to the secret being contributed, where all of the exponent blinding factors sum to unity. The dealer nodes share with the computing nodes the product of the secrets with the base blinding factor raised to the exponent blinding factor. Each computing nodes can independently and without sharing computations, generate from the product of shares it receives from the dealer nodes a result share. Summing the result shares provides the result of the computation. In this way a sum of products can be computed by the computing nodes without requiring any messages to pass between the computing nodes during the computation.

In one aspect there is provided a computer-implemented method, carried out between a plurality of D dealer nodes and N computing nodes, of calculating the result of an arithmetic function ƒ which can be expressed as the addition of A groups of multiplications of a set S of private input secrets {s₀, s₁, . . . , sₛ₋₁} such that:

$$f = f ( {s}_{0} , {s}_{1} , ... , {s}_{S - 1} ) = {m}_{0} + {m}_{1} + … + {m}_{A - 1} = {\sum }_{a = 0}^{A - 1} {m}_{a}$$

where each group of multiplications mₐ, a ∈{0, 1, . . . , A-1} is the product of Mₐ secrets of said set S of private input secrets:

$${m}_{a} = {s}_{{i}_{a , o}} \cdot {s}_{{i}_{a , 1}} \cdot … \cdot {s}_{{i}_{a , {M}_{a} - 1}} = {\prod }_{m = 0}^{{M}_{a} - 1} {s}_{{i}_{a , m}}$$

and the subindices i_{a,m} for a ∈{0, 1, . . . , A-1}, m ∈{0, 1, . . . , Mₐ-1} identify private input secrets from the set of S secrets, and where the S secrets are selected from integers, real numbers or complex numbers, and each secret is known to one of said dealer nodes, wherein the method comprises:
a) providing each dealer node contributing a secret sᵢ_{_{a,m}} to a group of multiplications mₐ with a base blinding factor ρₐ which is common to all secrets contributing to said group of multiplications mₐ, wherein the base blinding factor ρₐ satisfies (modulo p, where p is a prime number):

$${ρ}_{a}^{- 1} = {\sum }_{n = 0}^{N - 1} {X}_{n , a}$$

for a set of (N×A) random or pseudorandom numbers X_{n,a} for n ∈{0, 1, . . . , N-1}, a ∈{0, 1, . . . , A-1} each associated with a respective one of the N computing nodes;
b) providing each dealer node contributing a secret sᵢ_{_{a,m}} to a group of multiplications mₐ with an exponent blinding factor λ_{a,m} which is specific to said secret sᵢ_{_{a,m}}, wherein the set of exponent blinding factors λ_{a,m} collectively satisfy (modulo p):

$${\sum }_{m = 0}^{{M}_{a} - 1} {λ}_{a , m} = 1$$

c) storing said set of (N×A) random or pseudorandom numbers X_{n,a} for n ∈{0, 1, . . . , N-1}, a ∈{0, 1, . . . , A-1} either (i) at the computing nodes in a first mode of operation (“network mode”) whereby each of the N computing nodes stores a subset of A random or pseudorandom numbers unique to that node, or (ii) at the dealer nodes in a second mode of operation (“edge mode”) whereby each dealer node stores at least the subset of the (N×A) random or pseudorandom numbers X_{n,a} corresponding to the additions to which that dealer contributes a secret;
d) each dealer node computing, for each secret sᵢ_{_{a,m}}, one or more shares for that secret wherein in the network mode of operation a single share is computed, modulo p, as:

$${v}_{a , m} = {s}_{{i}_{a , m}} \cdot {ρ}_{a}^{{λ}_{a , m}}$$

and wherein in the edge mode of operation a plurality of N shares are computed, using the N random or pseudorandom numbers X_{n,a} associated with the group of multiplications mₐ to which the secret sᵢ_{_{a,m}} contributes, modulo p, as:

$${v}_{n , a , m} = {s}_{{i}_{a , m}} \cdot {ρ}_{a}^{{λ}_{a , m}} \cdot {X}_{n , a}$$

e) each dealer node sending to each of the computing nodes a respective share message which, in the network mode of operation contains the same single share v_{a,m}, and in the edge mode of operation contains a respective one of the N shares v_{n,a,m} such that each of the N computing nodes receives the shares indexed to a unique value n ∈{0, 1, . . . , N-1};
f) each computing node calculating, for the received shares v_{a,m} or v_{n,a,m} associated with each group of multiplications mₐ, a local product result which in the network mode of operation is calculated, modulo p, as:

$${r}_{n , a} = {X}_{n , a} \cdot {\prod }_{m = 0}^{{M}_{a} - 1} {v}_{a , m}$$

and which in the edge mode of operation is calculated, modulo p, as:

$${r}_{n , a} = {\prod }_{m = 0}^{{M}_{a} - 1} {v}_{n , a , m}$$

g) each computing node calculating a local addition result from the set of local product results, modulo p, as:

$${r}_{n} = {\sum }_{a = 0}^{A - 1} {r}_{n , a}$$

h) computing an output of the function ƒ by combining the local addition results from the N computing nodes to compute:

$$f = f ( {s}_{0} , {s}_{1} , … , {S}_{S - 1} ) = {\sum }_{n = 0}^{N - 1} {r}_{n} mod p .$$

By providing the dealer nodes with the two different kinds of blinding factors defined above, i.e. the base blinding factors and the exponent blinding factors, the shares sent from the dealers are obfuscated in a way that perfectly hides the secrets from the computing nodes, and that also allows the computing nodes to independently each perform a computation resulting in a result share, where the result shares can be combined without knowledge of the blinding factors or the secrets to reveal the result of the computation.

The methods of the invention employ a new flavour of SMPC called NMC (Nil Message Compute) which can evaluate any function in the arithmetic setting without the computing nodes having to exchange any message during the computation phase (Phase 2). NMC therefore removes the main performance problem from standard SMPC and it is capable of evaluating nontrivial functions over a large number of private inputs and using a large number of computing nodes in essentially the same time as it takes in a centralized computation where all information is available in clear inside of a single server. NMC as presented in this invention is secure against passive adversaries who are able to corrupt up to N-1 from a total of N computing nodes. Passive adversaries by definition follow the protocol specification but try to learn information about the private inputs s₀, s₁, . . . , sₛ₋₁ to the computation.

The methods in their most basic form focus on the arithmetic setting and on functions returning only one number. The same methods can be readily extended to any number of output values using the techniques described in Appendix A.3 of Damgård I., Pastro V., Smart N., Zakarias S. (2012) “Multiparty Computation from Somewhat Homomorphic Encryption”. In: Safavi-Naini R., Canetti R. (eds) Advances in Cryptology—CRYPTO 2012. CRYPTO 2012. Lecture Notes in Computer Science, vol 7417. Springer, Berlin, Heidelberg. https://doi.org/10.1007/978-3-642-32009-5_38. The contents of this reference are incorporated herein by reference for this purpose.

Preferably, step h) comprises:
(i) each computing node sending a local addition result rₙ to one or more result nodes; and
(ii) the one or more result nodes performing the summation of the received local addition results to determine the result of an arithmetic function ƒ.

Preferably, step a) comprises:
(i) each computing node n, n ∈{0, 1, . . . , N-1} generating a random number X_{n,a};
(ii) each computing node computing a share ρₐ(n+1) of a polynomial ρₐ(X) of degree N-1 such that (mod p):

$${ρ}_{a}^{- 1} = {p}_{a} ( 0 ) = {\sum }_{n = 0}^{N - 1} {X}_{n , a}$$

(iii) each computing node sending its share of each ρₐ⁻¹ to each dealer node d, d ∈{0, 1, . . . , D-1}; and
(iv) each dealer node reconstructing from the received shares the corresponding base blinding factor ρₐ⁻¹.

Preferably, step (ii) comprises:
providing a collection of random number generators G_{n,q} for n, q ∈{0, . . . , N-1} with n≠q, such that G_{n,q} is a generator that computing nodes n and q run in sync with one another;
each computing node n generating N-1 random shares from the random number generators G_{n,q} for each q ∈{0, . . . , N-1}, with q≠n to generate a respective random evaluation of a polynomial pₙ(q+1);
each computing node n computing the coefficients of the polynomial pₙ(x) which satisfies each of the random evaluations pₙ(q+1) and satisfies pₙ(0)=X_{n,a};
each computing node n computing from said coefficients and X_{n,a} a share pₙ(n+1) of the polynomial pₙ(x);
each computing node n generating p_{q}(n+1) from the random number generators G_{n,q} for each q ∈{0, . . . , N-1}, as its own share of the polynomial p_{q}(x) from every other computing node q;
each node computing Σ_{q=0}^{N-1}p_{q}(n+1) mod p to provide a share p(n+1) of the polynomial pₐ(x) evaluated at n+1;
each computing node sending its share p(n+1) of pₐ(x) each dealer node contributing to the group of multiplications mₐ such that each dealer node can reconstruct the independent coefficient of pₐ(x) corresponding to x⁰, which is which is equal to the sum of the secrets

$${ρ}_{a}^{- 1} = {\sum }_{n = 0}^{N - 1} {X}_{n , a} .$$

Further preferable aspects of the method include the generation of the exponent blinding factors in a collaborative manner to satisfy the constraint Σₘ₌₀^{M}^{ₐ}⁻¹λ_{a,m}=1. This is preferably done using the algorithm GenerateBlindingFactors described further below.

There is provided, as a further and independent aspect of invention, a method of distributing the initial shares from a secret sharing mechanism without sending any message as described below under the algorithm ZeroMessageShareDistribution. This can be applied, outside the context of the multiparty computation methods described herein, to any secret sharing mechanism that makes use of the generation of random numbers.

There is also provided, as yet a further and independent aspect of invention, a method of N nodes jointly adding N secrets and revealing the result of the sum of the secrets to one or more output nodes, while keeping the individual secrets private, as described below under the algorithm AddSecretsWithoutSendingTheirShares. It will be appreciated that this too can be applied outside the context of the multiparty computation methods described herein.

There is also provided, as yet a further and independent aspect of invention, a method of Mₐ-1 nodes jointly generating Mₐ secret numbers λ₀, λ₁, . . . , λ_{M}_{ₐ}₋₁ such that their sum equals one without sharing these numbers amongst themselves, as described below under the algorithm GenerateBlindingFactors. It will be appreciated that this too can be applied outside the context of the multiparty computation methods described herein.

### BRIEF DESCRIPTION OF THE DRAWINGS

FIG. 1 is a network diagram of a conventional SMPC network of dealer nodes, computing nodes and result nodes;

FIG. 2 is a network diagram of the computing nodes and dealer nodes of FIG. 1 implementing the Network NMC algorithm disclosed herein;

FIG. 3 is a flowchart including message flows, illustrating the Network NMC algorithm;

FIG. 4 is a network diagram of the computing nodes and dealer nodes of FIG. 1 implementing the Edge NMC algorithm disclosed herein; and

FIG. 5 is a flowchart including message flows, illustrating the Edge NMC algorithm.

### DETAILED DESCRIPTION OF PREFERRED EMBODIMENTS

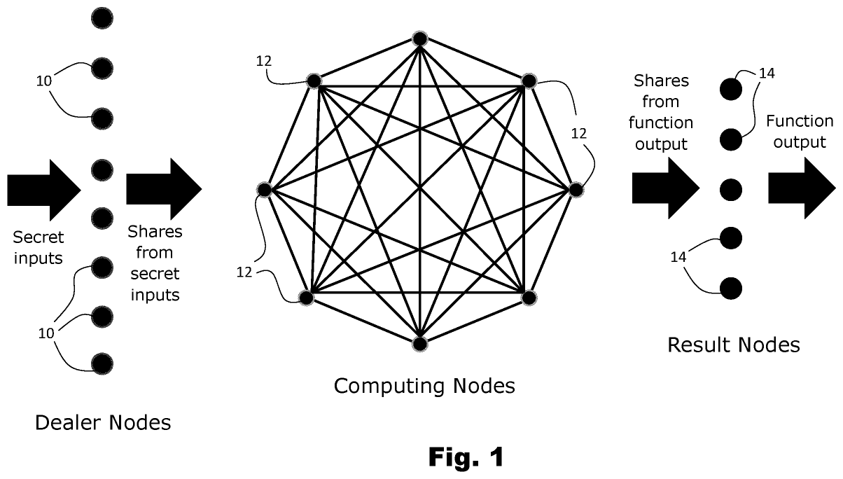

FIG. 1 is a network diagram showing a plurality of nodes that co-operate to perform a secure multiparty computation (SMPC). The nodes are categorised as dealer nodes 10, computing nodes 12, and result nodes 14.

Not all of the nodes are labelled with a reference numeral but it should be understood that all nodes in the same group are of the same type i.e. all nodes in the left vertical line are dealer nodes 10, all nodes in the central octagonal group are computing nodes, and all nodes in the right vertical line are result nodes.

It should also be understood by the skilled person that the arrangement and number of nodes is not intended to represent any specific reality, and nodes are likely to be arranged into logical rather than physical groups, with nodes able to communicate with any other node via a network address on a public or private network which could be a local area network, or a wide area network. Nodes could be even part of the same computing system e.g. different processors or cores in a multiprocessor system. Communication protocols are at the choice of the system designer and are likely to be dictated by the application and security requirements of the system in which they are implemented.

Each node may be implemented in a processor of a computing system which is programmed to perform the relevant methods and algorithms disclosed herein, and further has access to a memory, and a network connection. In many implementations, each node will be a suitably programmed computer system.

The dealer nodes 10 contribute inputs to the computation. Specifically, they are provided with secret inputs, and create shares from these secret inputs and distribute them among the computing nodes 12. The computing nodes perform the actual SMPC computation and each computing node 12 provides a share of a computation output to each result node 14. The result nodes 14 reconstruct the result from the received result shares.

In what follows, we make the following assumptions:
Assumption 1: A dealer node cannot be a computing node. Otherwise, a node can have more than one role.
Assumption 2: The number of computing nodes is equal or larger than the number of dealer nodes.
Assumption 3: There are secure point-to-point channels between different nodes in the network. In addition, message broadcasting is also supported.
Assumption 4: Without loss of generality, we assume that for every addition term mₐ there is at most only one input per dealer, because if a dealer contributes with more than one input variable to the product mₐ, it can always replace them with a new input variable equal to their product.
Assumption 5: Without loss of generality, we work with finite field arithmetic Z/pZ. That is, secrets are all represented as integers modulo p, where p is a prime number. All the computations that follow are therefore performed modulo p, represented as mod p. The arithmetic function ƒ defined in claim 1 can then be expressed more succinctly as:

$$f = f ( {s}_{0} , {s}_{1} , … , {s}_{S - 1} ) = {\sum }_{a = 0}^{A - 1} {\prod }_{m = 0}^{{M}_{a} - 1} {s}_{{i}_{a , m}} mod p \qquad Eq . 1$$

Assumption 6: We are working in the semi-honest adversary model, also known as security in the presence of passive adversaries. That is, the nodes in the network may use any means to try to obtain information about the secret inputs from the messages they receive but they follow the steps described in the NMC protocol.

First, we describe below three novel algorithms which constitute building blocks for NMC. Second, we describe two flavours of NMC, one in which most of the computations corresponding to the pre-processing phase are done by the SMPC computing nodes, and one in which they are done by the dealer nodes.

### Building Blocks

In this section we present three algorithms. The first one, ZeroMessageShareDistribution, is based on a novel idea that allows distributing the initial shares from a secret sharing mechanism without sending any message. The second, AddSecretsWithoutSendingTheirShares, makes use of this idea to allow computing nodes to add numbers without requiring the dealer nodes to send their shares. The third, GenerateBlindingFactors, makes use of AddSecretsWithoutSendingTheirShares in order for N nodes to come up with Mₐ numbers λ₀, λ₁, . . . , λ_{M}_{ₐ}₋₁ such that Σₘ₌₀^{M}^{ₐ}⁻¹λₘ=1, once again without initially distributing any shares.

The general principle of algorithm ZeroMessageShareDistribution can be applied to any secret sharing mechanism that makes use of the generation of random numbers. We present this algorithm for GMW SMPC and then we show in Phase 1 of algorithm AddSecretsWithoutSendingTheirShares how it is instantiated for BGW SMPC.

### 1) Description of Algorithm: ZeroMessageShareDistribution for GMW SMPC

Inputs: N input nodes, whereby node n has a secret xₙ, n ∈{0, 1, . . . , N-1}
Output: Each node ends up with a share of each other node's secret
Purpose: The shares are distributed without any message exchange

In GMW SMPC, each dealer n contributing with a secret bit xₙ generates N-1 random bits x_{n,0}, x_{n,1}, . . . , x_{n,n-1}, x_{n,n+1}, . . . , x_{n, N-1} such that x_{n,0}⊕x_{n,1}⊕ . . . ⊕x_{n,N-1}=xₙ by setting x_{n,n}=xₙ ⊕ (⊕_{q≠n}x_{n,q}). Then, dealer n sends random number x_{n,q} to Node q, for q≠i. That is, each node n is sending N-1 messages. That is a total number of N(N-1) messages. Instead of sending all these messages, the dealers can use random number generators in sync as follows.

Let G_{n,q} be a collection of random number generators, for n, q ∈{0, . . . , N-1} with n≠q, such that G_{n,q} is a generator that nodes n and q run in sync, and which generates random bits.

That is, nodes n and q can independently obtain the same sequence of random numbers from G_{n,q}.

We write g←G_{n,q} to denote when a node runs the number generator G_{n,q} to produce a random bit g. Each node n proceeds as follows in order to generate N shares x_{n,0}, x_{n,1}, . . . , x_{n,N-1} from their secret bit xₙ:
Step 1—Generate (N-1) random shares. Node n uses G_{n,q} for each q ∈{0, . . . , N-1}, with q≠n to generate a random share (i.e. a random bit) x_{n,q}←G_{n,q} for their secret bit xₙ.
Step 2—Generate their own share. Node n now has N-1 shares for their secret bit xₙ. With one more evaluation the total set of shares will be complete. Node n choses x_{n,n}=xₙ ⊕(⊕_{q≠n}x_{n,j}) as their own share to their secret bit.

In step 1 above, node n uses G_{n,q} to generate the random share x_{n,q} from their secret bit xₙ that needs to be sent to node q, with n≠q. However, both nodes n and q have an instance of the same random number generator G_{n,q} running in sync. Therefore, node q can independently obtain x_{n,q}←G_{n,q}, without any need for communication. Following this principle, every node n is able to generate their own share x_{n,n} from the 2-step process described above, and their share x_{n,q} from the secret bit x_{q} from every other input node q using x_{q,n}←G_{q,n} without ever having to receive or send a single message. This constitutes the novel procedure that allows the input nodes to distribute the shares from their secret bits without exchanging any message.

This ends the description of the algorithm ZeroMessageShareDistribution.

BGW SMPC makes use of Shamir's Secret Sharing (SSS) mechanism in order for the nodes to generate shares from their secret input values to the SMPC computation. The main idea in SSS is for a node n to hide their secret xₙ ∈ Z/pZ inside a polynomial:

$${p}_{n} ( x ) = {x}_{n} + {a}_{1 , n} x + {a}_{2 , n} {x}^{2} + … + {a}_{N - 1 , n} {x}^{N - 1} mod p$$

with random coefficients a_{1,n}, a_{2,n}, . . . , a_{N-1,n} such that the polynomial evaluated at x=0 is equal to the secret: pₙ(0)=xₙ. Given that N points are enough to uniquely determine a polynomial of degree N-1, the n-th dealer generates N polynomial evaluations pₙ(1), pₙ(2), . . . , pₙ(N) at a set of predetermined abscissae x=1, 2, . . . , N and sends a different evaluation to each one of the computing nodes. At the end of this process, each computing node j,j ∈{0, . . . , N-1} ends up with a share pₙ(j+1) evaluated at its assigned abscissa x=j+1 from a polynomial pₙ(x),n ∈{0, . . . , N-1} that hides a secret xₙ at pₙ(0)=xₙ.

Algorithm ZeroMessageShareDistribution can be used with any secret sharing mechanism that makes use of the generation of random numbers. Such is the case of Shamir's Secret Sharing mechanism in BGW SMPC, which works with random polynomial coefficients. We now show how this algorithm can be instantiated in the BGW SMPC case in order to allow the input nodes to send their shares from their secret inputs without any message exchange. This constitutes Phase 1 of algorithm AddSecretsWithoutSendingTheirShares. This algorithm shows how N nodes can add N secrets without disclosing them.

### 2) Description of Algorithm: AddSecretsWithoutSendingTheirShares

Inputs: N input nodes, whereby node n has a secret xₙ, n ∈{0, 1, . . . , N-1}
Output: One or several output nodes reconstruct the sum Σₙ₌₀^{N-1}xₙ mod p
Purpose: N nodes can jointly add N secrets and reveal the result of the sum to the output nodes whilst keeping their secrets private.

The algorithm comprises the 3 standard SMPC phases, whereby Phase 1 is an instantiation of algorithm ZeroMessageShareDistribution for Shamir's Secret Sharing mechanism. Phases 2 and 3 are the same as in the standard BGW SMPC.

### Phase 1—Share Distribution

We describe the instantiation of algorithm ZeroMessageShareDistribution for Shamir's Secret Sharing mechanism.

Let G_{n,q} be a collection of random number generators, for n, q ∈{0, . . . , N-1} with n≠q, such that G_{n,q} is a generator that nodes n and q run in sync, and which generates random numbers in Z/pZ.

That is, nodes n and q can independently obtain the same sequence of random numbers from G_{n,q}. A simple implementation of G_{n,q} is a cryptographic hash function that takes its output as an input to produce the next number provided that both nodes n and q start with the same initial input value. However, any pseudo-random number generator that outputs random numbers in Z/pZ will work.

We write g←G_{n,q} to denote when a node runs the number generator G_{n,q}. Each node n proceeds as follows in order to generate N evaluations from their polynomial pₙ(x):
Step 1—Generate (N-1) random shares pₙ(q+1), n≠q. Node n uses G_{n,q} for each q ∈{0, . . . , N-1}, with q≠n to generate a random evaluation of its polynomial pₙ(q+1)←G_{n,q}. This evaluation constitutes a share from secret xₙ.
Step 2—Generate its own share pₙ(n+1). Node n now has N-1 evaluations (shares) of a polynomial of degree N-1. With one more evaluation the polynomial will be fully characterised. Node n choses pₙ(0)=xₙ as the N-th evaluation. The polynomial pₙ(x) is now fully characterised but pₙ(0) cannot be a valid share because it is equal to the secret xₙ. In order to obtain the missing share pₙ(n+1) node n performs polynomial interpolation (e.g. using Lagrange) and obtains the coefficients a_{1,n}, . . . , a_{N-1,n} of its polynomial pₙ(x)=xₙ+a_{1,n}x+a_{2,n}x²+ . . . +a_{N-1,n} x^{N-1} mod p. With these coefficients and xₙ, node n computes pₙ(n+1) through direct evaluation, which is their share to their own polynomial.

In step 1 above, node n uses G_{n,q} to generate the random evaluation of their polynomial pₙ(q+1) that needs to be sent to node q, with n≠q. However, both nodes n and q have an instance of the same random number generator G_{n,q} running in sync. Therefore, node q can independently obtain pₙ(q+1)←G_{n,q}, without any need for communication. Following this principle, every node n is able to generate their own share pₙ(n+1) from the 2-step process described above, and their share p_{q}(n+1) from the polynomial p_{q}(x) from every other computing node q using p_{q}(n+1)←G_{q,n} without ever having to receive or send a single message. This constitutes the novel procedure that allows the computing nodes to distribute the shares from their secret without exchanging any message so that they can jointly compute their sum using BGW SMPC.

### Phase 2—Computation

This part of the algorithm follows the standard BGW SMPC. Every node n now has a share p_{q}(n+1) from a polynomial p_{q}(x) of degree N-1 such that p_{q}(0)=x_{q} is the secret from node q ∈{0, 1, . . . , N-1}, q≠n. We define the polynomial:

$$p ( x ) = {\sum }_{n = 0}^{N - 1} {p}_{n} ( x ) mod p$$

This is a polynomial of degree N-1 such that p(0)=Σₙ₌₀^{N-1} xₙn mod p. This is the sum of all the secrets and it constitutes the output of this algorithm. Following the standard BWG SMPC, by adding all their shares p(n+1)=Σ_{q=0}^{N-1}p_{q}(n+1) mod p, node n can compute their share p(n+1) of p(x) evaluated at n+1.

### Phase 3—Result Reconstruction

Continuing with the standard BGW SMPC, each node sends their share p(n+1) of p(x) to one or several output nodes. When an output node has received all the shares, it performs polynomial interpolation and reconstructs the independent coefficient a₀ (i.e. the one that corresponds to x⁰) which is equal to the sum of the secrets: a₀=Σₙ₌₀^{N-1}xₙ.

This ends the description of the algorithm AddSecretsWithoutSendingTheirShares.

### 3) Description of Algorithm: GenerateBlindingFactors

Inputs: Mₐ-1 input nodes.
Output: Mₐ output nodes, whereby the m-th result node, m ∈{0, 1, . . . , Mₐ-1} reconstructs the blinding factor λₘ, such that

$${\sum }_{m = 0}^{{M}_{a} - 1} {λ}_{m} = 1$$

Purpose: Mₐ-1 nodes jointly generate Mₐ blinding factors λ₀, λ₁, . . . , λMₐ₋₁ such that their sum equals one without sharing these factors amongst themselves. This algorithm allows the input nodes to reveal the m-th blinding factor λₘ to each node m from a total of Mₐ dealer nodes.
Step 1: Each input node m, m∈{0, 1, . . . , Mₐ-2} generates a random number λₘ. That is, each one generates a number in the series λ₀, λ₁, . . . , λ_{M}_{ₐ}₋₂ (all lambdas in the sum except for the last one λ_{M}_{ₐ}₋₁)
Step 2: Each input node m, m ∈{0, 1, . . . , Mₐ-2} runs algorithm AddSecretsWithoutSendingTheirShares using λₘ as their secret input:
   At the end of Phase 1 in algorithm AddSecretsWithoutSendingTheirShares, each input node m, m ∈{0, 1, . . . , Mₐ-2} ends up having a polynomial share p₀(m+1), p₁(m+1), . . . , p_{M}_{ₐ}₋₂(m+1) from each random number λ₀, λ₁, . . . , λ_{M}_{ₐ}₋₂, respectively
   At the end of Phase 2 in algorithm AddSecretsWithoutSendingTheirShares, each input node m, m ∈{0, 1, . . . , Mₐ-2} ends up having a polynomial share p_{†}(m+1) from a polynomial p_{†}(x) that is equal to the sum of λ₀, λ₁, . . . , λ_{M}_{ₐ}₋₂ when evaluated at x=0: p_{†}(0)=(Σₘ₌₀^{M}^{ₐ}⁻²λₘ) mod p.

Each input node m calculates (mod p):

$${p}_{{M}_{a} - 1} ( m + 1 ) = 1 - {p}_{†} ( m + 1 )$$

with its local share p_{†}(m+1) of p_{†}(x). Since Shamir Secret Sharing is linear, p_{M}_{ₐ}₋₁(m+1) turns out to be a share of a polynomial p_{M}_{ₐ}₋₁(x) hiding the value (1-Σₘ₌₀^{M}^{ₐ}-2λₘ) mod p when evaluated at x=0. That is, we define λ_{M}_{ₐ}₋₁ as follows (mod p

$${λ}_{{M}_{a - 1}} = {p}_{{M}_{a} - 1} ( 0 ) = ( 1 - {\sum }_{m = 0}^{{M}_{a} - 2} {λ}_{m} )$$

This ensures that (mod p):

$${\sum }_{m = 0}^{{M}_{a} - 1} {λ}_{m} = 1 \qquad Eq . 3$$

To summarise, each input node m, m ∈{0, 1, . . . , Mₐ-2} has now a polynomial share p₀ (m+1), p₁(m+1), . . . , p_{M}_{ₐ}₋₁(m+1) from Mₐ polynomials p₀ (x), p₁(x), . . . , p_{M}_{ₐ}₋₁(x) hiding secrets λ₀, λ₁, . . . , λ_{M}_{ₐ}-1, such that Eq. 3 holds.

At the end of Phase 3 from algorithm AddSecretsWithoutSendingTheirShares, each input node m, m ∈{0, 1, . . . , Mₐ-2} then sends each polynomial share pₖ(m+1) of λₖ to thek-th output node, withk∈{0, 1, . . . , Mₐ-1}, so that output node k can reconstruct λₖ.

This ends the description of the algorithm GenerateBlindingFactors.

### NMC SMPC—Formal Definition

Recall from Eq. 1 the general form of a function in the arithmetic setting

$$f = f ( {s}_{0} , {s}_{1} , … , {s}_{S - 1} ) = {\sum }_{a = 0}^{A - 1} {\prod }_{m = 0}^{{M}_{a} - 1} {s}_{{i}_{a , m}} mod p$$

We have D dealer nodes contributing secrets from the set {s₀, s₁, . . . , sₛ₋₁} to the computation of a generic arithmetic function given by Eq. 1. This computation is carried out by N computing nodes, and the corresponding result is revealed to R result nodes. We present two flavours of the novel NMC SMPC to solve this problem:
1) Network NMC: in this flavour the bulk of the computational load in the pre-computing phase is carried out by the N computing nodes.
2) Edge NMC: in this flavour the bulk of this load is carried out by the D dealer nodes.

Instead of directly applying a linear secret sharing (LSS) schema to the secret inputs, the idea underpinning both NMC flavours is to mask the secret inputs using blinding factors and then to use LSS (such as Shamir) to store some of these factors in the network of computing. More specifically:
1) In the Network NMC the masked value v from input secret s is given by v=s·ρ^{λ}, where Shamir shares from ρ and λ are generated and stored by the network of computing nodes
2) In the Edge NMC the masked value v from input secret s is given by v=s·X·ρ^{λ} where Shamir shares from λ are generated and stored by the network of computing nodes, and X and ρ are generated by the dealer nodes We now define the four phases of the Network NMC SMPC to evaluate this function.

### Description of Algorithm Network NMC

Inputs: D dealer nodes, whereby the n-th node holds a subset Sₙ of the total set of secrets S={s₀, s₁, . . . , sₛ₋₁}. The dealer nodes wish to compute an arithmetic function ƒ=ƒ(s₀, s₁, . . . , sₛ₋₁) over their secrets given by Eq. 1
Output: R result nodes reconstruct the function result ƒ=Σₐ₌₀^{A-1}Πₘ₌₀^{M}^{ₐ}⁻¹sᵢ_{_{a,m}} mod p comprising A additions, whereby the a-th addition comprises Mₐ multiplications. This function is computed by N computing nodes that are not able to see any of the input secrets.
Purpose: N computing nodes can jointly evaluate any arithmetic function whilst keeping the dealers' secrets private and without any message exchange during the computation phase. Algorithm Network NMC comprises four phases: Pre-processing, Share Distribution, Computation and Result Reconstruction.

### Phase 0—Pre-Processing

This phase deals with the computation of a base blinding factor ρₐ and Mₐ exponent blinding factors λ_{a,0}, λ_{a,1}, λ_{a,M}_{ₐ}₋₁ such that Σₘ₌₀^{M}^{ₐ}⁻¹λ_{a,m}=1 (mod p), for each addition a, a ∈{0, 1, . . . , A-1}.

The following steps are executed in parallel for each addition a, a ∈{0, 1, . . . , A-1}:
Step 1 (computation of the base blinding factor):
   Each computing node n, n ∈{0, 1, . . . , N-1} generates a random number X_{n,a}.
Step 2 (computation of the base blinding factor):
   Each computing node n runs algorithm AddSecretsWithoutSendingTheirShares, using X_{n,a} as their secret input value in order to jointly calculate Σₙ₌₀^{N-1}X_{n,a}. At the end of Phase 2 in this algorithm, each node n has a share pₐ(n+1) of a polynomial pₐ(x) of degree N-1 such that (mod p):

$${p}_{a} ( 0 ) = {\sum }_{n = 0}^{N - 1} {X}_{n , a}$$

We denote this by ρₐ⁻¹=pₐ(0), the inverse of the baseline blinding factor. In the Result Reconstruction phase of algorithm AddSecretsWithoutSendingTheirShares, each computing node sends their share of each ρₐ⁻¹ to each dealer node d, d ∈{0, 1, . . . , D-1}. Each dealer node is then able to reconstruct (mod p):

$${ρ}_{a}^{- 1} = {\sum }_{n = 0}^{N - 1} {X}_{n , a} \qquad Eq . 2$$

Step 3 (computation of the exponent blinding factors):
   In parallel to the two steps presented above, the N computing nodes organise themselves in A subsets S₀, S₁, . . . , S_{A-1} of M₀-1, M₁-1, . . . , M_{A-1}-1 computing nodes, respectively. For each addition a, a ∈{0, 1, . . . , A-1}, the computing nodes from the a-th subset Sₐ work in collaboration to compute Mₐ random values λ_{a,0}, λ_{a,1}, . . . , λ_{a,M}_{ₐ}₋₁ (blinding factors) such that Σₘ₌₀^{M}^{ₐ}⁻¹λ_{a,m}=1 (mod p). They achieve this by running GenerateBlindingFactors with Sₐ as the subset of input nodes. That is, as a result from the parallel execution of A instances of algorithm GenerateBlindingFactors, each dealer node d, d ∈{0, 1, . . . , D-1} can reconstruct λ_{a,m}, if they participate with secret sᵢ_{_{a,m}} in the computation of the product Πₘ₌₀^{M}^{ₐ}⁻¹sᵢ_{_{a,m}} corresponding to the a-th addition in Eq. 1, such that for every a ∈{0, 1, . . . , A-1}, λ_{a,m} fulfils:

$${\sum }_{m = 0}^{{M}_{a} - 1} {λ}_{a , m} = 1 \qquad Eq . 3$$

Note of the A subsets S₀, S₁, . . . , S_{A-1} of computing nodes: These subsets can be chosen according to any arbitrary method. Assumption 2 guarantees that such subsets exist. In another embodiment, the a-th subset Sₐ of Mₐ-1 computing nodes is expanded to any arbitrary number Nₐ, Mₐ-1≤Nₐ; N of computing nodes by adding N-(Mₐ-1) nodes, whereby the m-th added node generates λ_{a,m}=0 in Step 1 of algorithm GenerateBlindingFactors, for all a ∈{0, 1, . . . , A-1}, so that Eq. 3 is not altered.

Note on performance: The computation of ρₐ⁻¹ and of λ_{a,m} for each addition a, a ∈{0, 1, . . . , A-1} requires the execution of Phase 3 from algorithm AddSecretsWithoutSendingTheirShares. This phase comprises the transmission of messages to every dealer node. By aggregating all the messages to a dealer node in one, each computing node needs to send only one message per dealer node. This is a total number of N·D messages in the network, where D is the number of dealer nodes.

At the end of the NMC pre-processing phase, each dealer node d, d ∈{0, 1, . . . , D-1} ends up with the blinding factors ρₐ⁻¹ (and hence ρₐ) and λ_{a,m}, a ∈{0, 1, . . . , A-1}, m ∈{0, 1, . . . , Mₐ-1} for every secret sᵢ_{_{a,m}} they contribute with to the overall SMPC computation. This phase is completely independent of the secrets s₀, s₁, . . . , sₛ₋₁, which are the inputs to the evaluation of the arithmetic function. Therefore, it can be executed before (e.g. months) the actual evaluation of the arithmetic function running NMC SMPC and it can be processed in batch.

### Phase 1—Share Distribution

Step 1: Each dealer node d ∈{0, 1, . . . , D-1} masks their secret (mod p):

$${v}_{a , m} = {s}_{{i}_{a , m}} \cdot {ρ}_{a}^{{λ}_{a , m}}$$

if they contribute with secret sᵢ_{_{a,m}} to the computation of the multiplication comprising the a-th addition term in Eq. 1. Recall that in s_{a,m}, i_{a,m} acts as an index to the corresponding secret in the set s₀, s₁, . . . , sₛ₋₁. Recall also from Assumptions 3 that each dealer node only contributes with at most one secret to the a-th addition term in Eq. 1.
Step 2: Each dealer node d ∈{0, 1, . . . , D-1} sends one broadcast message to the N computing nodes containing one value v_{a,m} for each addition term a to which they contribute a secret. Each value v_{a,m} represents a NMC share their secret sᵢ_{_{a,m}}.

Note on security. Notice that the N computing nodes do not know the value of the base blinding factor ρₐ or of the exponent blinding factors λ_{a,m}, because all they have is a polynomial share of these values. Therefore, the factor ρₐ^{λ}^{_{a,m}} is effectively hiding the secret value sᵢ_{_{a,m}} and algorithm NMC inherits the security features from SSS, namely, it is secure against N-1 (or less) colluding nodes in the passive adversary model. Specifically, an adversary would have to corrupt all N computing nodes in order to be able to reconstruct ρₐ and λ_{a,m} in order to recover sᵢ_{_{a,m}} from v_{a,m}.

### Phase 2—Computation

Step 1: Each computing node n, n ∈{0, 1, . . . , N-1} calculates for each addition a, a ∈{0, 1, . . . , A-1} (mod p):

$${r}_{n , a} = {X}_{n , a} \cdot {\prod }_{m = 0}^{{M}_{a} - 1} {v}_{a , m} \qquad Eq . 4$$

Step 2: Each computing node n, n ∈{0, 1, . . . , N-1} calculates (mod p):

$${r}_{n} = {\sum }_{a = 0}^{A - 1} {r}_{n , a} \qquad Eq . 5$$

This phase does not require any communication between the computing nodes since each node n can locally compute r_{n,a} for each a ∈{0, 1, . . . , A-1}.

### Phase 3—Result Reconstruction

Each computing node n, n ∈{0, 1, . . . , N-1} sends their NMC share rₙ of the result to the result nodes, which compute:

$$f = f ( {s}_{0} , {s}_{1} , … , {S}_{S - 1} ) = {\sum }_{n = 0}^{N - 1} {r}_{n} mod p \qquad Eq . 6$$

This ends the description of the algorithm Network NMC.

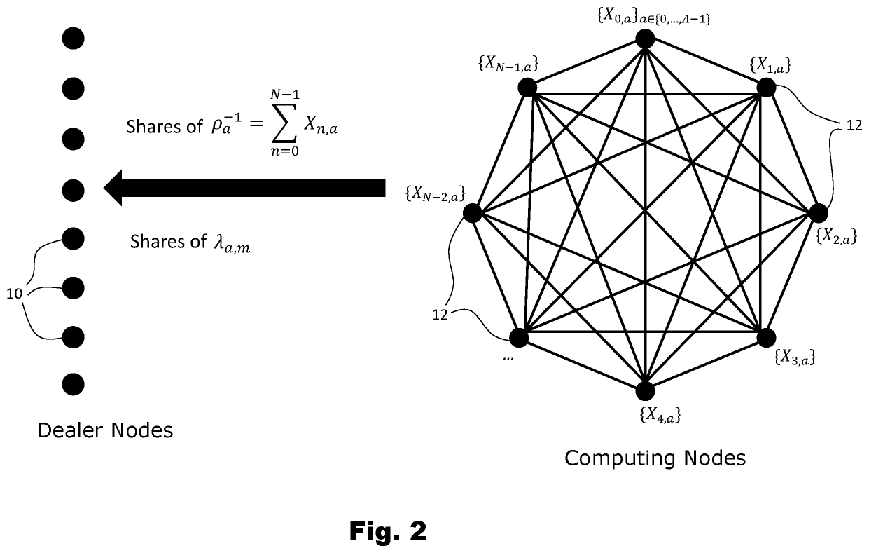

FIG. 2 shows the computing nodes 12 and the dealer nodes 10 from FIG. 1, carrying out the steps of Phase 0—Pre-processing for the Network NMC implementation.

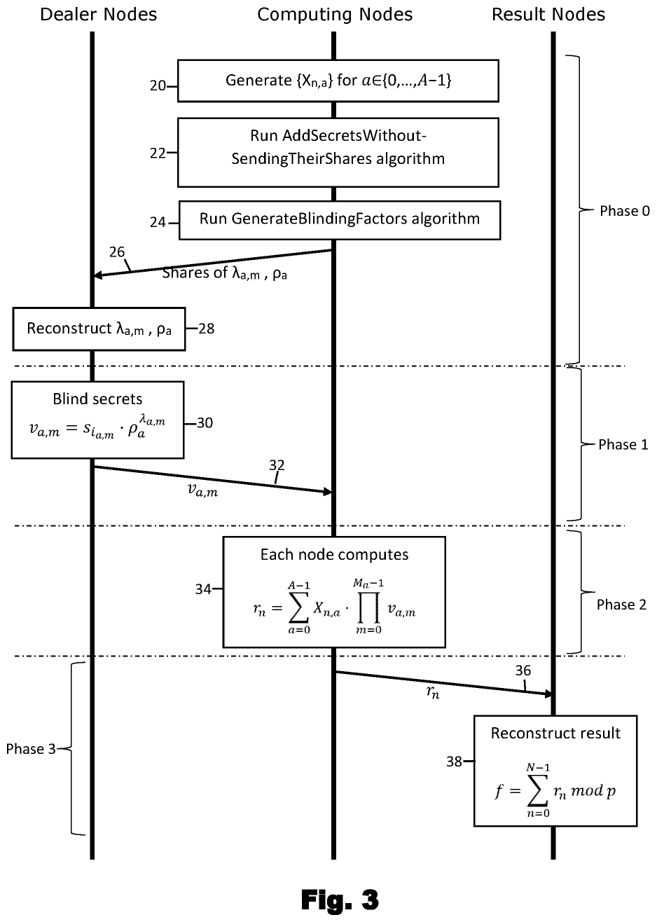

Referring additionally to FIG. 3, this is a flowchart which includes message flows between the nodes for the Network NMC implementation.

In step 20, each computing node n of the N computing nodes n ∈{0, 1, . . . , N-1}, generates a random number X_{n,a}. This is done in parallel for each addition a, a ∈{0, 1, . . . , A-1} as described for Step 1 of Phase 0 above.

In step 22, the computing nodes each run the algorithm AddSecretsWithoutSendingTheirShares using X_{n,a} as their secret input value as described in the first part of Step 2 of Phase 0 above. This results in each computing node having a share of each ρₐ⁻¹ which can be sent to the dealer nodes.

In step 24, the computing nodes run GenerateBlindingFactors in parallel in A instances to compute shares of λ_{a,m} as described in the first part of Step 3 of Phase 0.

In step 26, the computing nodes send the shares calculated in steps 22 and 24 of FIG. 3 to the dealer nodes as described in the latter parts of Steps 2 and 3 of Phase 0.

In step 28, the dealer nodes reconstruct the blinding factors λ_{a,m}, ρₐ using Shamir Secret Sharing's polynomial interpolation (e.g. using Lagrange's method). As noted at the end of the description of Phase 0 above, the steps leading to the reconstruction of the blinding factors can be carried out a long time in advance of the share blinding and distribution steps of Phase 1.

It should also be noted that alternative ways of providing the blinding factors are envisaged. For example, in another embodiment, a trusted node carries out the computations from the pre-processing phase and sends ρₐ⁻¹ and of λ_{a,m} for each addition a, a ∈{0, 1, . . . , A-1} to the dealer nodes.

In another embodiment, the N computing nodes carry out the computations from the pre-processing phase using another SMPC flavour different from the one described in algorithm AddSecretsWithoutSendingTheirShares and send messages to the dealer nodes that allow them to reconstruct ρₐ⁻¹ and of λ_{a,m} for each addition a, a ∈{0, 1, . . . , A-1}.

In another embodiment, homomorphic encryption is used by one or several nodes, for instance using Full Homomorphic Encryption, or Somewhat Homomorphic Encryption as described in SPDZ (Damg5rd I., Pastro V., Smart N., Zakarias S. (2012) Multiparty Computation from Somewhat Homomorphic Encryption. In: Safavi-Naini R., Canetti R. (eds) Advances in Cryptology—CRYPTO 2012. CRYPTO 2012. Lecture Notes in Computer Science, vol 7417. Springer, Berlin, Heidelberg. https://doi.org/10.1007/978-3-642-32009-5_38), to carry out the computations from the pre-processing phase and sends pₐ⁻¹ and of λ_{a,m} for each addition a, a ∈{0, 1, . . . , A-1} to the dealer nodes.

In another embodiment, one or several nodes use secure enclaves or trusted execution environments to carry out the computations from the pre-processing phase and send ρₐ⁻¹ and of λ_{a,m} for each addition a, a ∈{0, 1, . . . , A-1} to the dealer nodes.

Returning to FIG. 3, in step 30, and as is described above in Phase 1, each dealer node 10 may compute v_{a,m}=sᵢ_{_{a,m}}·ρₐ^{λ}^{_{a,m}} for the secret sᵢ_{_{a,m}} contributed to the computation of the multiplication comprising the a-th addition term.

In step 32, the result of each such computation is broadcast by the dealer node creating the computation to the computing nodes.

In step 34, and as described above for Phase 2, each computing node calculates a share rₙ of the result of the NMC computation, and does so without any communication between the computing nodes.

In step 36, each computing node sends its share rₙ to the result nodes.

In step 38, the result nodes reconstruct the result of the function ƒ as the sum of the result shares mod p, according to Eq. 6. It can be shown that this reconstruction, arrived at without any communication between the computing nodes, is indeed a valid result of a multi-party computation of a function in the arithmetic setting by the following proof.

Starting from Eq. 4 and 5 we have (mod p):

$$\begin{matrix}{r}_{n} = {\sum }_{a = 0}^{A - 1} {r}_{n , a} \\ = {\sum }_{a = 0}^{A - 1} {X}_{n , a} \cdot {\prod }_{m = 0}^{{M}_{a} - 1} {v}_{a , m} \\ = {\sum }_{a = 0}^{A - 1} {X}_{n , a} \cdot {\prod }_{m = 0}^{{M}_{a} - 1} {{s}_{i}}_{a , m} \cdot {ρ}_{a}^{{λ}_{a , m}} \\ = {\sum }_{a = 0}^{A - 1} {ρ}_{a}^{{λ}_{a , 0}} \cdot {ρ}_{a}^{{λ}_{a , 1}} \cdot … \cdot {ρ}_{a}^{{λ}_{a , {M}_{a - 1}}} \cdot {X}_{n , a} \cdot {\prod }_{m = 0}^{{M}_{a} - 1} {{s}_{i}}_{a , m} \\ = {\sum }_{a = 0}^{A - 1} {ρ}_{a}^{{λ}_{a , 0} + {λ}_{a , 1} + … + {λ}_{a , {M}_{a - 1}}} \cdot {X}_{n , a} \cdot {\prod }_{m = 0}^{{M}_{a} - 1} {{s}_{i}}_{a , m} \\ = {\sum }_{a = 0}^{A - 1} {ρ}_{a} \cdot {X}_{n , a} \cdot {\prod }_{m = 0}^{{M}_{a} - 1} {{s}_{i}}_{a , m}\end{matrix}$$

where the last step comes from the fact that λ_{a,0}+λ_{a,1}+ . . . +λ_{a,M}_{ₐ}₋₁=1, which follows from Eq. 3. By plugging this result into the right-hand side of Eq. 6 we get (mod p):

$$\begin{matrix}{\sum }_{n = 0}^{N - 1} {r}_{n} = {\sum }_{n = 0}^{N - 1} {\sum }_{a = 0}^{A - 1} {ρ}_{a} \cdot {X}_{n , a} \cdot {\prod }_{m = 0}^{{M}_{a} - 1} {{s}_{i}}_{a , m} \\ = {\sum }_{a = 0}^{A - 1} {\sum }_{n = 0}^{N - 1} {ρ}_{a} \cdot {X}_{n , a} \cdot {\prod }_{m = 0}^{{M}_{a} - 1} {{s}_{i}}_{a , m} \\ = {\sum }_{a = 0}^{A - 1} {ρ}_{a} {\prod }_{m = 0}^{{M}_{a} - 1} {{s}_{i}}_{a , m} \cdot {\sum }_{n = 0}^{N - 1} {X}_{n , a} \\ = {\sum }_{a = 0}^{A - 1} {ρ}_{a} \cdot {ρ}_{a}^{- 1} {\prod }_{m = 0}^{{M}_{a} - 1} {{s}_{i}}_{a , m} \\ = {\sum }_{a = 0}^{A - 1} {\prod }_{m = 0}^{{M}_{a} - 1} {{s}_{i}}_{a , m}\end{matrix}$$

which corresponds to ƒ=ƒ(s₀, s₁, . . . , Sₛ₋₁) in Eq. 1.

It will be recalled from Assumption 4 that every dealer contributes with at most 1 secret to the product corresponding to the a-th addition term in ƒ. In another embodiment, we force every dealer node m to contribute with exactly one secret sᵢ_{_{a,m}} to the product corresponding to the a-th addition term, for every addition term a ∈{0, 1, . . . , A-1}.

We achieve this as follows: (1) if the dealer was already contributing with one secret to the a-th term, then we do nothing, (2) if the dealer was not contributing with a secret, then it forces its secret to be equal to one: sᵢ_{_{a,m}}=1. This way, the product Πₘ₌₀^{M}^{ₐ}⁻¹sᵢ_{_{a,m}} in the a-th term is not altered but every dealer node contributes with exactly one secret to it. This allows replacing Mₐ=D for every addition term a, and making all random vectors λ_{a,m} be equal to a single random vector λₘ, whereby Eq. 3 becomes

$${\sum }_{m = 0}^{D - 1} {λ}_{m} = 1$$

and the same λₘ are used for each addition term. This allows a reduction in the amount of information sent by the computing nodes to the dealer nodes at the end of Phase 0. Instead of sending shares for ρₐ⁻¹ and λ_{a,m}, a ∈{0, 1, . . . , A-1} and m∈{0, 1, . . . , Mₐ-1}, they just send shares for ρₐ⁻¹ and λₘ, m ∈{0, 1, . . . , D-1}.

As discussed previously, as an alternative to the Network NMC algorithm the same outcome can be achieved, again without any communication between the computing nodes, using an algorithm referred to as Edge NMC.

We now define the four phases of the Edge NMC SMPC for the joint evaluation of the arithmetic function in Eq. 1 without revealing any input secret value. In Edge NMC SMPC we push most of the complexity in the pre-processing phase to the dealer nodes. This involves changing (relative to the Network NMC algorithm) Steps 1 and 2 in Phase 0, the whole Phase 1 and Step 1 in Phase 2 as follows:

### Description of Algorithm Edge NMC

Inputs: As in Network NMC
Output: As in Network NMC
Purpose: As in Network NMC

### Phase 0: Pre-Processing

New Step 1 (replacing the old one):
   All D dealer nodes run a random number generator in sync. That is, by running it, they independently obtain the same N·A random numbers X_{n,a} without any message exchange, n ∈{0, 1, . . . , N-1}, a ∈{0, 1, . . . , A-1}.
New Step 2 (replacing the old one):
   Every dealer node d ∈{0, 1, . . . , D-1} locally computes:

$${ρ}_{a}^{- 1} = {\sum }_{n = 0}^{N - 1} {X}_{n , a}$$

Step 3 remains the same.
   The N computing nodes compute the shares of the exponent blinding factors by running GenerateBlindingFactors as described for the Network NMC Algorithm, then reveal the shares of {λ_{a,m}}, a ∈{0, 1, . . . , A-1}, m ∈{0, 1, . . . , Mₐ-1} to the different dealers allowing them to reconstruct the blinding factor λ_{a,m} that hides their secret sᵢ_{_{a,m}}.

### Phase 1: Share Distribution (Replacing the Old One):

Step 1: Each dealer node d ∈{0, 1, . . . , D-1} computes (mod p):

$${v}_{n , a , m} = {s}_{{i}_{a , m}} \cdot {ρ}_{a}^{{λ}_{a , m}} \cdot {X}_{n , a}$$

for n ∈{0, 1, . . . , N-1}, a ∈{0, 1, . . . , A-1} if they contribute with secret sᵢ_{_{a,m}} to the computation of the multiplication comprising the a-th addition term in Eq. 1. Notice that there are the N shares v_{0,a,m}, v_{1,a,m}, . . . , v_{N-1,a,m} that correspond to every secret sᵢ_{_{a,m}}.
Step 2: Each dealer node d ∈{0, 1, . . . , D-1} sends each one of the N shares v_{0,a,m}, v_{1,a,m}, . . . , v_{N-1,a,m} that correspond to every secret sᵢ_{_{a,m}} owned by node d to a different computing node.

### Phase 2: Computation

Step 1 (replacing the old one):
   Each computing node n, n ∈{0, 1, . . . , N-1} calculates for each addition a, a ∈{0, 1, . . . , A-1} (mod p):

$${r}_{n , a} = {\prod }_{m = 0}^{{M}_{a} - 1} {v}_{n , a , m} , \qquad Eq . 4$$

Step 2: As in Network NMC.

### Phase 3—Result Reconstruction

As in Network NMC.

This ends the description of the algorithm Edge NMC.

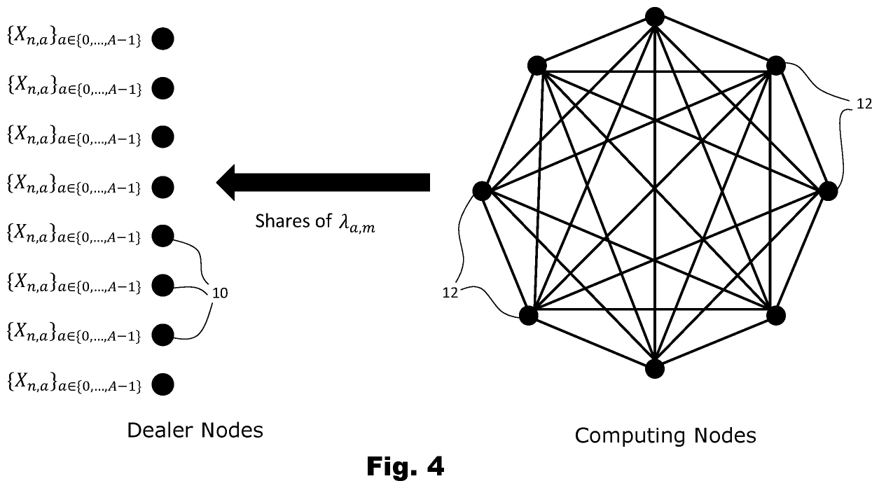

FIG. 4 shows the computing nodes 12 and the dealer nodes 10 from FIG. 1, carrying out the steps of Phase 0—Pre-processing for the Edge NMC implementation.

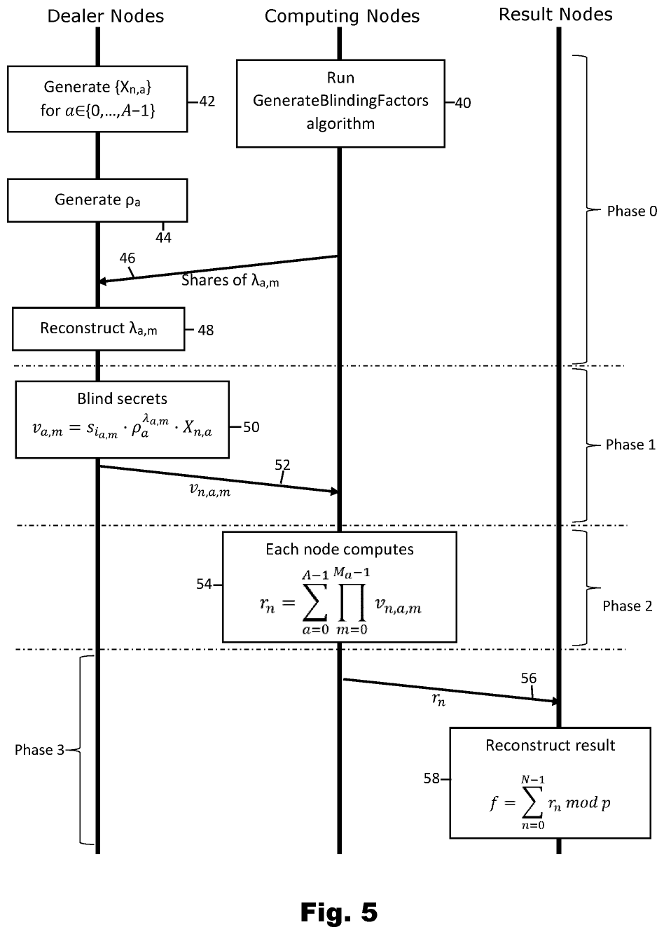

Referring additionally to FIG. 5, this is a flowchart which includes message flows between the nodes for the Edge NMC implementation.

In step 40, the computing nodes run GenerateBlindingFactors in parallel in A instances to compute shares of λ_{a,m} as described in the first part of Step 3 of Phase 0 of the Edge NMC algorithm above.

In step 42 (which may be carried out before, after or in parallel with step 20), each dealer node runs a random generator in sync to generate the same set of random numbers X_{n,a} without any message exchange, as described in Step 1 of Phase 0.

In step 44, each dealer node locally computes ρₐ (or ρ⁻¹ₐ) as set out in Step 2 of Phase 0.

In step 46, the computing nodes send the shares of λ_{a,m} calculated in step 40 to the dealer nodes.

In step 48, the dealer nodes reconstruct λ_{a,m} from the revealed shares. The skilled person will appreciate that the same options exist for providing the blinding factors to the dealer nodes as in the Network NMC algorithm.

In step 50, as described above in Phase 1, each dealer node 10 computes the N shares v_{0,a,m}, v_{1,a,m}, . . . , v_{N-1,a,m} that correspond to every secret s as described for Step 1 of Phase 1.

In step 52, these shares are sent to the respective computing nodes as described for Step 2 of Phase 1.

In step 54, the computing nodes calculated the modified version of the result shares rₙ according to Phase 2.

In step 56, the result shares are sent to the result nodes, and in step 58, the result nodes reconstruct the result of the function ƒ.

The proof for the Edge NMC flavour is almost the same as that for Eq. 6 in the Network NMC flavour, the only difference being that instead of X_{n,a}·Πₘ₌₀^{M}^{ₐ}⁻¹v_{a,m} in Edge NMC we have Πₘ₌₀^{M}^{ₐ}⁻¹v_{n,a,m}. Both are equal since by definition X_{n,a}·Πₘ₌₀^{M}^{ₐ}⁻¹v_{a,m}=X_{n,a}·Πₘ₌₀^{M}^{ₐ}⁻¹sᵢ_{_{a,m}}·ρₐ^{λ}^{_{a,m}} and Πₘ₌₀^{M}^{ₐ}⁻¹v_{n,a,m}=X_{n,a}·Πₘ₌₀^{M}^{ₐ}⁻¹sᵢ_{_{a,m}}·ρₐ^{λ}^{_{a,m}}. Sometimes, dealer nodes just want to use the network of computing nodes to store and reconstruct an input secret value. We now discuss this process in both NMC protocols.

In Phase 1 of the Network NMC protocol, a dealer node masks a secret using v_{a,m}=sᵢ_{_{a,m}}·ρₐ^{λ}^{_{a,m}} and broadcasts it to the network of computing nodes, whereby each computing node has a share from ρₐ and λ_{a,m}. When the dealer node wants to reconstruct its secret it requests the network of computing nodes to send their share from ρₐ and λ_{a,m} as well as v_{a,m}. Using Shamir Secret Sharing, the dealer node reconstructs ρₐ and λ_{a,m} and computes its secret input value as follows (mod p): sᵢ_{_{a,m}}=v_{a,m}·ρₐ^{-λ}^{_{a,m}}

In Phase 1 of the Edge NMC protocol, a dealer node masks a secret using v_{n,a,m}=sᵢ_{_{a,m}}·ρₐ^{λ}^{_{a,m}}·X_{n,a} and broadcasts it to the network of computing nodes, whereby each computing node has a share from λ_{a,m}. Notice that this does not allow for the reconstruction of the secret input sᵢ_{_{a,m}}. We now describe a modification of Phase 1 so that this reconstruction is possible. In the modified version of Phase 1, the dealer uses a linear secret sharing scheme such as Shamir's in order to compute and distribute among the computing nodes the shares from X_{n,a} and ρₐ. When the dealer node wants to reconstruct its secret, it requests the network of computing nodes to send their share from ρₐ, X_{n,a} and λ_{a,m} as well as v_{n,a,m}. Using Shamir Secret Sharing, the dealer node reconstructs ρₐ, X_{n,a} and λ_{a,m} and computes its secret input value as follows (mod p): sᵢ_{_{a,m}}=v_{n,a,m}·ρₐ^{-λ}^{_{a,m}}·X_{n,a}⁻¹

1. A computer-implemented method, carried out between a plurality of D dealer nodes and N computing nodes, of calculating the result of an arithmetic function ƒ which can be expressed as the addition of A groups of multiplications of a set S of private input secrets {s₀, s₁, . . . , sₛ₋₁} such that:
$$f = f ( {s}_{0} , {s}_{1} , … , {s}_{S - 1} ) = {m}_{0} + {m}_{1} + … + {m}_{A - 1} = {\sum }_{a = 0}^{A - 1} {m}_{a}$$
where each group of multiplications mₐ, a ∈{0, 1, . . . , A-1} is the product of Mₐ secrets of said set S of private input secrets:
$${m}_{a} = {s}_{{i}_{a , o}} \cdot {s}_{{i}_{a , 1}} \cdot … \cdot {s}_{{i}_{a , {M}_{a} - 1}} = {\prod }_{m = 0}^{{M}_{a} - 1} {s}_{{i}_{a , m}}$$
and the subindices i_{a,m} for a ∈{0, 1, . . . , A-1},m ∈{0, 1, . . . , Mₐ-1} identify private input secrets from the set of S secrets, and where the S secrets are selected from integers, real numbers or complex numbers, and each secret is known to one of said dealer nodes, wherein the method comprises:
a) providing each dealer node contributing a secret sᵢ_{_{a,m}} to a group of multiplications mₐ with a base blinding factor ρₐ which is common to all secrets contributing to said group of multiplications mₐ, wherein the base blinding factor ρₐ satisfies (modulo p, where p is a prime number):
$${ρ}_{a}^{- 1} = {\sum }_{n = 0}^{N - 1} {X}_{n , a}$$
for a set of (N×A) random or pseudorandom numbers X_{n,a} for n ∈{0, 1, . . . , N-1}, a ∈{0, 1, . . . , A-1} each associated with a respective one of the N computing nodes;
b) providing each dealer node contributing a secret sᵢ_{_{a,m}} to a group of multiplications mₐ with an exponent blinding factor λ_{a,m} which is specific to said secret sᵢ_{_{a,m}}, wherein the set of exponent blinding factors λ_{a,m} collectively satisfy (modulo p):
$${\sum }_{m = 0}^{{M}_{a} - 1} {λ}_{a , m} = 1$$
c) storing said set of (N×A) random or pseudorandom numbers X_{n,a} for n ∈{0, 1, . . . , N-1}, a ∈ {0, 1, . . . , A-1} either (i) at the computing nodes in a first mode of operation (“network mode”) whereby each of the N computing nodes stores a subset of A random or pseudorandom numbers unique to that node, or (ii) at the dealer nodes in a second mode of operation (“edge mode”) whereby each dealer node stores at least the subset of the (N×A) random or pseudorandom numbers X_{n,a} corresponding to the additions to which that dealer contributes a secret;
d) each dealer node computing, for each secret sᵢ_{_{a,m}}, one or more shares for that secret wherein in the network mode of operation a single share is computed, modulo p, as:
$${v}_{a , m} = {s}_{{i}_{a , m}} \cdot {ρ}_{a}^{{λ}_{a , m}}$$
and wherein in the edge mode of operation a plurality of N shares are computed, using the N random or pseudorandom numbers X_{n,a} associated with the group of multiplications mₐ to which the secret sᵢ_{_{a,m}} contributes, modulo p, as:
$${v}_{n , a , m} = {s}_{{i}_{a , m}} \cdot {ρ}_{a}^{{λ}_{a , m}} \cdot {X}_{n , a}$$
e) each dealer node sending to each of the computing nodes a respective share message which, in the network mode of operation contains the same single share v_{a,m}, and in the edge mode of operation contains a respective one of the N shares v_{n,a,m} such that each of the N computing nodes receives the shares indexed to a unique value n ∈{0, 1, . . . , N-1};
f) each computing node calculating, for the received shares v_{a,m} or v_{n,a,m} associated with each group of multiplications mₐ, a local product result which in the network mode of operation is calculated, modulo p, as:
$${r}_{n , a} = {X}_{n , a} {\prod }_{m = 0}^{{M}_{a} - 1} {v}_{a , m}$$
and which in the edge mode of operation is calculated, modulo p, as:
$${r}_{n , a} = {\prod }_{m = 0}^{{M}_{a} - 1} {v}_{n , a , m}$$
g) each computing node calculating a local addition result from the set of local product results, modulo p, as:
$${r}_{n} = {\sum }_{a = 0}^{A - 1} {r}_{n , a}$$
h) computing an output of the function ƒ by combining the local addition results from the N computing nodes to compute:
$$f = f ( {s}_{0} , {s}_{1} , … , {S}_{S - 1} ) = {\sum }_{n = 0}^{N - 1} {r}_{n} mod p .$$

2. The computer-implemented method of claim 1, wherein step h) comprises:
(i) each computing node sending a local addition result rₙ to one or more result nodes; and
(ii) the one or more result nodes performing the summation of the received local addition results to determine the result of an arithmetic function ƒ.

3. The computer implemented method of claim 1, wherein step a) comprises:
(i) each computing node n, n ∈{0, 1, . . . , N-1} generating a random number X_{n,a};
(ii) each computing node computing a share ρₐ(n+1) of a polynomial ρₐ(x) of degree N-1 such that (mod p):
$${ρ}_{a}^{- 1} = {p}_{a} ( 0 ) = {\sum }_{n = 0}^{N - 1} {X}_{n , a}$$
(iii) each computing node sending its share of each ρₐ⁻¹ to each dealer node d, d ∈{0, 1, . . . , D-1}; and
(iv) each dealer node reconstructing from the received shares the corresponding base blinding factor ρₐ⁻¹.

4. The computer implemented method of claim 3, wherein step (ii) comprises: providing a collection of random number generators G_{n,q} for n, q ∈{0, . . . , N-1} with n≠q, such that G_{n,q} is a generator that computing nodes n and q run in sync with one another;
each computing node n generating N-1 random shares from the random number generators G_{n,q} for each q ∈{0, . . . , N-1}, with q≠n to generate a respective random evaluation of a polynomial pₙ(q+1);
each computing node n computing the coefficients of the polynomial pₙ(x) which satisfies each of the random evaluations pₙ(q+1) and satisfies pₙ(0)=X_{n,a};
each computing node n computing from said coefficients and X_{n,a} a share pₙ(n+1) of the polynomial pₙ(x);
each computing node n generating p_{q}(n+1) from the random number generators G_{n,q} for each q ∈{0, . . . , N-1}, as its own share of the polynomial p_{q}(x) from every other computing node q;
each node computing Σ_{q=0}^{N-1}p_{q}(n+1) mod p to provide a share p(n+1) of the polynomial ρₐ(x) evaluated at n+1;
each computing node sending its share p(n+1) of ρₐ(x) each dealer node contributing to the group of multiplications mₐ such that each dealer node can reconstruct the independent coefficient of ρₐ(x) corresponding to x⁰, which is which is equal to the sum of the secrets
$${ρ}_{a}^{- 1} = {Σ}_{n = 0}^{N - 1} {X}_{n , a} .$$

5. The computer implemented method of claim 1, wherein step a) comprises one of:
a. the dealer nodes receiving the base blinding factor ρₐ⁻¹ from a trusted node;
b. the computing nodes sending messages to the dealer nodes permitting then to reconstruct ρₐ⁻¹ for each addition a, a ∈{0, 1, . . . , A-1}, said messages being collaboratively generated by the dealer nodes from the secrets X_{n,a} using a secure multiparty computation;
c. one or more nodes other than the dealer nodes performing a homomorphic encryption to generate the base blinding factor ρₐ⁻¹, and sending this base blinding factor to the dealer nodes contributing to the addition a; or
d. one or more nodes other than the dealer nodes computing the base blinding factor ρₐ⁻¹ in a secure enclave or trusted execution environment, and sending the base blinding factor to the dealer nodes contributing to the addition a.

6. The computer implemented method of claim 2, wherein step a) comprises:
(i) each computing node n, n ∈{0, 1, . . . , N-1} generating a random number X_{n,a};
(ii) each computing node computing a share ρₐ(n+1) of a polynomial ρₐ(x) of degree N-1 such that (mod p):
$${ρ}_{a}^{- 1} = {p}_{a} ( 0 ) = {\sum }_{n = 0}^{N - 1} {X}_{n , a}$$
(iii) each computing node sending its share of each ρₐ⁻¹ to each dealer node d, d ∈{0, 1, . . . , D-1}; and
(iv) each dealer node reconstructing from the received shares the corresponding base blinding factor ρₐ⁻¹.

7. The computer implemented method of claim 2, wherein step a) comprises one of:
a. the dealer nodes receiving the base blinding factor ρₐ⁻¹ from a trusted node;
b. the computing nodes sending messages to the dealer nodes permitting then to reconstruct ρₐ⁻¹ for each addition a, a ∈{0, 1, . . . , A-1}, said messages being collaboratively generated by the dealer nodes from the secrets X_{n,a} using a secure multiparty computation;
c. one or more nodes other than the dealer nodes performing a homomorphic encryption to generate the base blinding factor ρₐ⁻¹, and sending this base blinding factor to the dealer nodes contributing to the addition a; or
d. one or more nodes other than the dealer nodes computing the base blinding factor ρₐ⁻¹ in a secure enclave or trusted execution environment, and sending the base blinding factor to the dealer nodes contributing to the addition a.
